(19) United States
(12) Patent Application Publication
(10) Pub. No.: US 2026/0019381 A1
(43) Pub. Date: Jan. 15, 2026

(54) APPARATUS AND METHOD FOR SCHEDULING NETWORK RESOURCES

(71) Applicant: Huawei Cloud Computing Technologies Co., Ltd., Gui'an New District (CN)

(72) Inventors: Zhenhua Hu, Toronto (CA); Xiayue Yang, Markham (CA); Nodir Kodirov, Vancouver (CA); Prerak Jigneshkumar Choksi, Unionville (CA); Shane Anthony Bergsma, Markham (CA)

(21) Appl. No.: 18/770,363

(22) Filed: Jul. 11, 2024

(51) Int. Cl. H04L 47/83; H04L 41/16

(52) U.S. Cl. CPC H04L 47/83; H04L 41/16

(57) ABSTRACT

Provided are an apparatus and a method for scheduling network resources. In response to a resource request for a resource consumer, the resource scheduler obtains resource prediction including the predicted network bandwidth and the predicted network usage pattern, and schedules bandwidths for the resource consumer based on resource requirement information, the resource prediction and resource availability. The network bandwidths for the resource consumer are allocated based on the predicted network bandwidth and the predicted network usage pattern, network bandwidths can be allocated based on demand and supply, and can thus be fully utilized, that is, network bandwidth utilizations at the endpoint and the levels of networks can be improved.

### TECHNICAL FIELD

The present disclosure relates to the field of technologies of cloud computing, and in particular, to an apparatus and a method for scheduling network resources.

### BACKGROUND

In cloud computing, compute, storage and network resources are managed by resource schedulers. Clients submit resource consumer requests to the schedulers to get compute, storage and network resources to run applications, where resource consumers may include virtual machines (VMs), containers, etc.

It is more challenging and difficult to schedule network resources than compute or storage resources, because the latter is host-based resources that only need to consider individual physical compute or storage servers; whereas the former is topology-based resources that need to consider multiple physical network links and switches that connect two or more physical compute or storage servers in hierarchical/layered topologies. It is difficult to schedule bandwidths/network resources when adding or removing virtual endpoints (such as VMs, containers, computer applications and services, etc.) in an existing data center network, such as to support auto-scaling use cases.

This background information is provided to reveal information believed by the applicant to be of possible relevance to the present disclosure. No admission is necessarily intended, nor should be construed, that any of the preceding information constitutes prior art against the present disclosure.

### SUMMARY

In a first aspect, an embodiment of the present disclosure provides a method for scheduling network resources, and the method includes:
receiving, by a resource scheduler from a client, a resource request indicating at least one resource consumer;
receiving, by the resource scheduler from a predictor, resource prediction based on the resource request, where the resource prediction includes a predicted network bandwidth and a predicted network usage pattern for each of the at least one resource consumer, where the resource prediction is obtained by the predictor through prediction inferring based on a pre-trained model, and the pre-trained model is obtained from local and central training; and
scheduling, by the resource scheduler based on resource requirement information, the resource prediction and resource availability, each of the at least one resource consumer onto an endpoint and levels of networks.

In a possible implementation of the first aspect, for each of the at least one resource consumer, the resource request indicates the resource requirement information for the resource consumer, identity information of at least one tenant associated with the resource consumer and at least one requested resource plan associated with the resource consumer, at least one of a requested network usage pattern or identity information of the resource consumer;
where the resource requirement information includes at least one of following items: an amount of CPU requested for the resource consumer, a size of a memory requested for the resource consumer, a network bandwidth requested for the resource consumer.

In a possible implementation of the first aspect, the scheduling, by the resource scheduler based on the resource requirement information, the resource prediction and the resource availability, each of the at least one resource consumer onto an endpoint and levels of networks includes:
scheduling, by the resource scheduler, each of the at least one resource consumer with a first bandwidth onto the endpoint based on the predicted network bandwidth and the predicted network usage pattern; and
scheduling, by the resource scheduler, each of the at least one resource consumer with corresponding second bandwidths onto the levels of networks based on the first bandwidth.

In a possible implementation of the first aspect, the scheduling, by the resource scheduler, each of the at least one resource consumer with the corresponding second bandwidths onto the levels of networks based on the first bandwidth includes:
determining, by the resource scheduler for each of the at least one resource consumer, the corresponding second bandwidths onto the levels of networks based on the first bandwidth;
for each of the levels of networks, determining, by the resource scheduler based on the predicted network usage pattern for each of the at least one resource consumer, whether a second bandwidth at a network level meets a preset bandwidth requirement for the network level; and
upon determining that the corresponding second bandwidths meet preset bandwidth requirements for the levels of networks, scheduling, by the resource scheduler, each of the at least one resource consumer with the corresponding second bandwidths onto the levels of networks.

In a possible implementation of the first aspect, the preset bandwidth requirement includes:
in a case that the predicted network usage pattern for a resource consumer is a low bandwidth pattern, the second bandwidth being allocated to the resource consumer at each of the levels of networks is from a reserved bandwidth quota, where the reserved bandwidth quota is shared among resource consumers with the low bandwidth pattern;
in a case that the predicted network usage pattern for the resource consumer is a sustained high bandwidth pattern, for each of the levels of networks, the second bandwidth being allocated to the resource consumer at the network level is from an available bandwidth and a sustained high available bandwidth;
in other cases, for each of the levels of networks, the second bandwidth being allocated to the resource consumer at the network level is from the available bandwidth.

In a possible implementation of the first aspect, the determination of the second bandwidths for each of the at least one resource consumer includes:
for a first network level among the levels of networks, a second bandwidth for the resource consumer at the first network level is obtained by multiplying the first bandwidth for the endpoint and a bandwidth percentage for the first network level;
for network levels other than the first network level, a second bandwidth for the resource consumer at an (n+1)-th network level is obtained by multiplying a second bandwidth for the resource consumer at an n-th network level and a bandwidth percentage for the (n+1)-th network level, wherein n is an integer greater than or equal to 1;
wherein the bandwidth percentage is greater than or equal to 0.0 or 0%, and smaller than or equal to 1.0 or 100%.

In a possible implementation of the first aspect, a second bandwidth for the resource consumer at the n-th network level is obtained by further multiplying a promotion rate for the n-th network level, where the promotion rate is greater than 0.0, and smaller than or equal to 1.0.

In a possible implementation of the first aspect, for each of the at least one resource consumer, the resource request indicates whether communication partners of a resource consumer in a placement domain at the n-th network level are all inside the placement domain;
in a case that the first bandwidth is smaller than or equal to a threshold, or the communication partners of the resource consumer are all inside the placement domain, the bandwidth percentage for the n-th network level is set to 0.0;
in a case that the communication partners of the resource consumer are all outside the placement domain, the bandwidth percentage for the n-th network level is set to 1.0;
in other cases, the bandwidth percentage for the placement domain at the n-th network level is set to an oversubscription rate between the n-th network level and an (n+1)-th network level.

In a possible implementation of the first aspect, the predicted network usage pattern is one of a low bandwidth pattern, a sustained high bandwidth pattern, a fluctuated high bandwidth pattern, or a bursty bandwidth pattern.

In a possible implementation of the first aspect, the pre-trained model is trained based on sampled network usage patterns of multiple groups of sampled resource consumers, bandwidth requirement information of sampled resource consumers in the multiple groups and sampled bandwidth utilization information of the sampled resource consumers in the multiple groups.

In a possible implementation of the first aspect,
for each sampled resource consumer in each of the multiple groups, the bandwidth requirement information and the sampled bandwidth utilization information are collected at each local host, and the sampled network usage pattern is determined at each local host based on the sampled bandwidth utilization information of the sampled resource consumer;
the training of the pre-trained model is performed for each of the multiple groups at a central location based on the bandwidth requirement information, the sampled bandwidth utilization information and the sampled network usage pattern from local hosts.

In a possible implementation of the first aspect, the grouping of the sampled resource consumers is based on a type of an application running on each sampled resource consumer or a sampled network usage pattern of each sampled resource consumer.

In a possible implementation of the first aspect, in a case that a candidate group has a data size less than a preset data size, one or more sampled resource consumers in the candidate group are mixed into a general group.

In a possible implementation of the first aspect, for each sampled resource consumer in each of the multiple groups:
the bandwidth requirement information of the sampled resource consumer includes at least one of: identity information of the sampled resource consumer, identity information of at least one tenant associated with the sampled resource consumer and at least one resource plan associated with the sampled resource consumer, identity information of a type of an application associated with the sampled resource consumer, resource requirement information and resource utilization information of the sampled resource consumer, a network usage pattern of the sampled resource consumer, a creation time and a deletion time of the sampled resource consumer;
the resource requirement information of the sampled resource consumer includes at least one of an amount of CPU requested for the sampled resource consumer, a size of a memory requested for the sampled resource consumer, or an assured bandwidth requested for the sampled resource consumer.

In a possible implementation of the first aspect, for each sampled resource consumer in each of the multiple groups, the sampled bandwidth utilization information of the sampled resource consumer indicates a historical bandwidth utilization during sampled resource consumer lifetime and includes at least one of following items:
a maximum utilized bandwidth, an average utilized bandwidth, a minimum utilized bandwidth or a 95-percentile utilized bandwidth during the sampled resource consumer lifetime.

In a second aspect, an embodiment of the present disclosure provides an apparatus for scheduling network resources, and the apparatus includes:
a first receiving module, configured to receive a resource request indicating at least one resource consumer;
a second receiving module, configured to receive resource prediction based on the resource request, where the resource prediction includes a predicted network bandwidth and a predicted network usage pattern for each of the at least one resource consumer, where the resource prediction is obtained through prediction inferring based on a pre-trained model, and the pre-trained model is obtained from local and central training; and
a scheduling module, configured to schedule, based on resource requirement information, the resource prediction and resource availability, each of the at least one resource consumer onto an endpoint and levels of networks.

In a possible implementation of the second aspect, for each of the at least one resource consumer, the resource request indicates the resource requirement information for the resource consumer, identity information of at least one tenant associated with the resource consumer and at least one requested resource plan associated with the resource consumer, at least one of a requested network usage pattern or identity information of the resource consumer;
where the resource requirement information includes at least one of following items: an amount of CPU requested for the resource consumer, a size of a memory requested for the resource consumer, a network bandwidth requested for the resource consumer.

In a possible implementation of the second aspect, the scheduling module is specifically configured to:
schedule each of the at least one resource consumer with a first bandwidth onto the endpoint based on the predicted network bandwidth and the predicted network usage pattern; and
schedule each of the at least one resource consumer with corresponding second bandwidths onto the levels of networks based on the first bandwidth.

In a possible implementation of the second aspect, the scheduling module is specifically configured to:
determine, for each of the at least one resource consumer, the corresponding second bandwidths onto the levels of networks based on the first bandwidth;
for each of the levels of networks, determine, based on the predicted network usage pattern for each of the at least one resource consumer, whether a second bandwidth at a network level meets a preset bandwidth requirement for the network level; and
upon determining that the corresponding second bandwidths meet preset bandwidth requirements for the levels of networks, schedule each of the at least one resource consumer with the corresponding second bandwidths onto the levels of networks.

In a possible implementation of the second aspect, the preset bandwidth requirement includes:
in a case that the predicted network usage pattern for a resource consumer is a low bandwidth pattern, the second bandwidth being allocated to the resource consumer at each of the levels of networks is from a reserved bandwidth quota, where the reserved bandwidth quota is shared among resource consumers with the low bandwidth pattern;
in a case that the predicted network usage pattern for the resource consumer is a sustained high bandwidth pattern, for each of the levels of networks, the second bandwidth being allocated to the resource consumer at the network level is from an available bandwidth and a sustained high available bandwidth;
in other cases, for each of the levels of networks, the second bandwidth being allocated to the resource consumer at the network level is from the available bandwidth.

In a possible implementation of the second aspect, the determination of the second bandwidths for each of the at least one resource consumer includes:
for a first network level among the levels of networks, a second bandwidth for the resource consumer at the first network level is obtained by multiplying the first bandwidth for the endpoint and a bandwidth percentage for the first network level;
for network levels other than the first network level, a second bandwidth for the resource consumer at an (n+1)-th network level is obtained by multiplying a second bandwidth for the resource consumer at an n-th network level and a bandwidth percentage for the (n+1)-th network level, where n is an integer greater than or equal to 1;
where the bandwidth percentage is greater than or equal to 0.0 or 0%, and smaller than or equal to 1.0 or 100%.

In a possible implementation of the second aspect, a second bandwidth for the resource consumer at the n-th network level is obtained by further multiplying a promotion rate for the n-th network level, where the promotion rate is greater than 0.0, and smaller than or equal to 1.0.

In a possible implementation of the second aspect, for each of the at least one resource consumer, the resource request indicates whether communication partners of a resource consumer in a placement domain at the n-th network level are all inside the placement domain;
in a case that the first bandwidth is smaller than or equal to a threshold, or the communication partners of the resource consumer are all inside the placement domain, the bandwidth percentage for the n-th network level is set to 0.0;
in a case that the communication partners of the resource consumer are all outside the placement domain, the bandwidth percentage for the n-th network level is set to 1.0;
in other cases, the bandwidth percentage for the placement domain at the n-th network level is set to an oversubscription rate between the n-th network level and an (n+1)-th network level.

In a possible implementation of the second aspect, the predicted network usage pattern is one of a low bandwidth pattern, a sustained high bandwidth pattern, a fluctuated high bandwidth pattern, or a bursty bandwidth pattern.

In a possible implementation of the second aspect, the pre-trained model is trained based on sampled network usage patterns of multiple groups of sampled resource consumers, bandwidth requirement information of sampled resource consumers in the multiple groups and sampled bandwidth utilization information of the sampled resource consumers in the multiple groups.

In a possible implementation of the second aspect,
for each sampled resource consumer in each of the multiple groups, the bandwidth requirement information and the sampled bandwidth utilization information are collected at each local host, and the sampled network usage pattern is determined at each local host based on the sampled bandwidth utilization information of the sampled resource consumer;
the training of the pre-trained model is performed for each of the multiple groups at a central location based on the bandwidth requirement information, the sampled bandwidth utilization information and the sampled network usage pattern from local hosts.

In a possible implementation of the second aspect, the grouping of the sampled resource consumers is based on a type of an application running on each sampled resource consumer or a sampled network usage pattern of each sampled resource consumer.

In a possible implementation of the second aspect, in a case that a candidate group has a data size less than a preset data size, one or more sampled resource consumers in the candidate group are mixed into a general group.

In a possible implementation of the second aspect, for each sampled resource consumer in each of the multiple groups:
the bandwidth requirement information of the sampled resource consumer includes at least one of: identity information of the sampled resource consumer, identity information of at least one tenant associated with the sampled resource consumer and at least one resource plan associated with the sampled resource consumer, identity information of a type of an application associated with the sampled resource consumer, resource requirement information and resource utilization information of the sampled resource consumer, a network usage pattern of the sampled resource consumer, a creation time and a deletion time of the sampled resource consumer;
the resource requirement information of the sampled resource consumer includes at least one of an amount of CPU requested for the sampled resource consumer, a size of a memory requested for the sampled resource consumer, or an assured bandwidth requested for the sampled resource consumer.

In a possible implementation of the second aspect, for each sampled resource consumer in each of the multiple groups, the sampled bandwidth utilization information of the sampled resource consumer indicates a historical bandwidth utilization during sampled resource consumer lifetime and includes at least one of following items:
a maximum utilized bandwidth, an average utilized bandwidth, a minimum utilized bandwidth or a 95-percentile utilized bandwidth during the sampled resource consumer lifetime.

In a third aspect, an embodiment of the present disclosure provides an apparatus for scheduling network resources, and the apparatus is configured to execute the method according to the first aspect or any possible implementation of the first aspect.

In a fourth aspect, an embodiment of the present disclosure provides an apparatus for scheduling network resources, and the apparatus includes at least one processor coupled with a memory, where the memory stores instructions that cause the at least one processor to execute the method according to the first aspect or any possible implementation of the first aspect.

In a fifth aspect, an embodiment of the present disclosure provides an apparatus for scheduling network resources, and the apparatus includes a processing circuitry for executing the method according to the first aspect or any possible implementation of the first aspect.

It should be noted that, the apparatus may be in a form of a computing device, an electronic device, etc.

In a sixth aspect, an embodiment of the present disclosure provides a computer-readable medium, and the computer-readable medium stores computer execution instructions which, when executed by a processor, cause the processor to execute the method according to the first aspect or any possible implementation of the first aspect.

In a seventh aspect, an embodiment of the present disclosure provides a computer program product, and the computer program product includes computer execution instructions which, when executed by a processor, cause the processor to execute the method according to the first aspect or any possible implementation of the first aspect.

In an eighth aspect, an embodiment of the present disclosure provides a computer program, and the computer program includes computer execution instructions which, when executed by a processor, cause the processor to execute the method according to the first aspect or any possible implementation of the first aspect.

### BRIEF DESCRIPTION OF THE DRAWINGS

The accompanying drawings are used to provide a further understanding of the present disclosure, constitute a part of the specification, and are used to explain the present disclosure together with the following specific embodiments, but should not be construed as limiting the present disclosure.

FIG. 1A is a schematic illustration of a resource hierarchy according to one or more embodiments of the present disclosure.

FIG. 1B is a schematic illustration of fat-tree network in related art.

FIG. 1C is a schematic illustration of expander-based network in related art.

FIG. 2 is a schematic illustration of an overall system architecture of resource scheduling according to one or more embodiments of the present disclosure.

FIG. 3 is a flowchart of a method for scheduling network resources according to one or more embodiments of the present disclosure.

FIGS. 4A-4D are schematic illustrations of a sustained high pattern, fluctuated high pattern, bursty pattern and a small traffic pattern, respectively, according to one or more embodiments of the present disclosure.

FIG. 5 is a schematic illustration of bandwidth level division according to one or more embodiments of the present disclosure.

FIG. 6 is a schematic illustration of bandwidths associated with the network usage patterns according to one or more embodiments of the present disclosure.

FIG. 7 is a block diagram of an apparatus for scheduling network resources according to one or more embodiments of the present disclosure.

FIG. 8 is a schematic structural diagram of an apparatus for scheduling network resources according to one or more embodiments of the present disclosure.

### DETAILED DESCRIPTION

In the following description, reference is made to the accompanying figures, which form part of the present disclosure, and which show, by way of illustration, specific aspects of embodiments of the present disclosure or specific aspects in which embodiments of the present disclosure may be used. It is understood that embodiments of the present disclosure may be used in other aspects and include structural or logical changes not depicted in the figures. The following detailed description, therefore, is not to be taken in a limiting sense, and the scope of the present disclosure is defined by the appended claims.

The following introduces possible terminologies in embodiments of the present disclosure.

Compute Servers (Hosts) or Storage Servers—Compute servers are physical servers to provide compute resources (e.g., CPU (Central Processing Unit), memory, GPU (Graphical Processing Unit) and others) to run VMs (virtual machines) and containers. Storage servers are physical servers to provide storage resources with storage spaces, I/O (input/output) bandwidths and latencies. In Cloud, compute servers and storage servers are connected by shared or dedicated networks. Interchangeably compute servers are also called physical hosts or hosts.

Clients—They are clients of Resource Scheduler, which can be from tenants, users, other cloud services, or other workloads/applications, etc.

Endpoints—They are physical or virtual components that connect to and exchange information with computer networks. Some examples of endpoints are mobile devices, desktop computers, embedded devices, servers, virtual machines, containers, computer applications and services. An endpoint generates, consumes and exchanges information with other endpoints. Whereas a network passes or delivers information among endpoints.

Resource Scheduler—In cloud computing, compute, storage and network resources are managed by resource scheduler. The clients submit resource allocation requests to the resource scheduler to get resources to run applications.

Resource Consumers (RCs)—They are requested or allocated resources based on resource allocation requests from clients. Allocated resource consumers can have compute resources that can be used to run endpoints such as VMs, containers, applications or services; can also have network resources to exchange information among endpoints.

Racks—A rack is a cabinet to mount a number of compute servers and/or storage servers, and network switches, which are interconnected with network links, powered electrical cables and power units.

PoDs—A Point-of-Deployment is a deployment of multiple racks of compute servers, storage servers and network switches.

DCs—Data Centers of a Cloud.

AZs—Availability Zones. An AZ is independent or isolated from other AZs in terms of failure blast radius.

Region—A Cloud region of multiple AZs.

Placement Domains (PDs)—A placement domain (PD) can be a physical server, a group of physical servers with shared physical resources or logical relations, a group of child PDs with shared physical resources or logical relations. PDs can be connected by physical network switches, and powered by power supplies. A PD can have its own resources (e.g., a rack has its ToR switch bandwidth), can also have (sum, minimum, maximum) statistics collected from its child PDs' resources (e.g., amounts of CPU and memory of physical servers under the rack). A compute or storage server is a leaf node in the topology or is a special PD.

Network bandwidth oversubscription—In a cloud data center, the aggregated bandwidth of an upper-level placement domain may be smaller than the aggregated bandwidth of a low-level placement domain. This saves network cost, because traffics are usually smaller at the upper-level placement domain. It is measured by an oversubscription ratio N:1, meaning N bandwidth units at the low-level placement domain only subscribe 1 unit at the upper-level placement domain. For easy calculation, we can also define the oversubscription rate R=1/N, where 0.0<R≤1.0 between two vertical adjacent levels. For example, the aggregated uplink bandwidth of a rack is 0.5 of its aggregated downlink bandwidth, which is also called oversubscription ratio of 2:1 at the rack level. The oversubscription ratio or rate is calculated by the actual aggregated downlink bandwidths, which is initially determined by initial network design layouts, and may be dynamically changed by dynamic network health conditions or dynamic network configuration (e.g., reconfigurable optical switches) as well.

Resource plan—On the resource demand side, a resource plan is a complex resource request of one or more resource consumers and their placement strategies about how the resource consumers are allocated in placement domains. The resource plan usually represents a certain type of applications or services from clients.

In cloud computing, compute, storage and network resources are managed by resource schedulers. The clients submit resource consumer requests to the resource schedulers, e.g., to get compute, storage and network resources to run applications, where resource consumers may include VMs, containers, etc.

It is more challenging and difficult to schedule network resources (network bandwidths) than compute or storage resources, because the latter is host-based resources that only need to consider individual physical compute or storage servers; whereas the former is topology-based resources that need to consider multiple physical network links and switches that connect two or more physical compute or storage servers in hierarchical/layered topologies. It is difficult to schedule network bandwidths when adding or removing virtual endpoints (such as VMs, containers, computer applications and services, etc.) in an existing data center network, such as to support auto-scaling use cases.

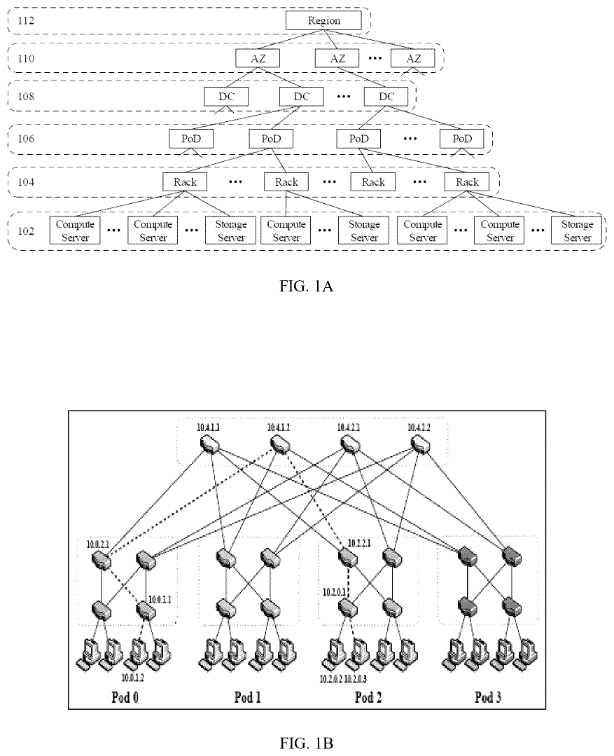

FIG. 1A illustrates a resource hierarchy of compute and storage servers that are connected by network switches and links organized in multiple levels of a tree or DAG (Directed Acyclic Graph) topology. As shown in FIG. 1A, from bottom to top, the resource hierarchy may include a first level or a physical host level 102, a second level or a rack level 104, a third level or a point of deployment (POD) level 106, a fourth level or a data center (DC) level 108, a fifth level or an availability zone (AZ) level 110, a sixth level or a region level 112. Corresponding explanations for each level may be understood with the aforementioned terminologies, which will not be repeated here.

FIG. 1B is a schematic illustration of fat-tree network, while FIG. 1C is a schematic illustration of expander-based network. The physical endpoints (physical servers/hosts) or leaf nodes at the bottom layer are connected by ToR (Top of Rack) switches in either fat-tree or other dense link topologies like Torus or Expander of bandwidth-fully connected clusters, so that the servers in a rack or cluster have fully-aggregated bandwidth without oversubscription. However, bandwidths at upper layers cross these racks or dense clusters are usually oversubscribed to save costs. Nevertheless, bandwidth utilizations at the bottom server level and the upper switch levels are still low in cloud data centers, overall average utilization <5%, average peak utilization <25%, maximum peak utilization >75%.

Problems of related methods for scheduling bandwidth resources when placing virtual endpoints (such as VMs, containers, computer applications and services) in cloud data centers may be at least as follows:
they are rigid on accuracy and exclusiveness, so that the guaranteed but unused bandwidth allocations for an application cannot be used by other applications;
they require recalculating, reallocating and changing the previously-allocated bandwidths for a cloud application or service at every endpoint and network nodes if the number of physical or virtual endpoints are increased or decreased for the application or service due to auto-scaling or other reasons;
they simply ignore bandwidths assuming that bandwidths are over-provisioned, resulting in most bandwidths underutilized.

These cause lots of bandwidth resources (i.e., network resources) wasted while network congestions or hot spots may still happen. That is why network bandwidth/resource utilizations at the physical endpoint level (such as physical servers or hosts) and network levels (such as switches and routers) are low in cloud data centers. We need better network bandwidth scheduling at the bottom/endpoint level and the upper/network levels.

In some solutions for scheduling bandwidth resources, under certain circumstances, the calculation of bandwidth may depend on the number of VMs outside the rack in which they are deployed, it is not practical to use existing models, such as CloudMirror TAG model in cloud data centers, since dynamic changes may be possible due to auto-scaling or other reasons, and such changes will require recalculating and reallocating the previously-allocated bandwidths.

In view of the above, embodiments of the present disclosure propose a method for scheduling network resources based on network bandwidth prediction and network usage pattern recognition to improve network resource utilization. The resource scheduler may schedule one or more resource consumers onto endpoint(s) and levels of networks in response to resource request(s) through the proposed method.

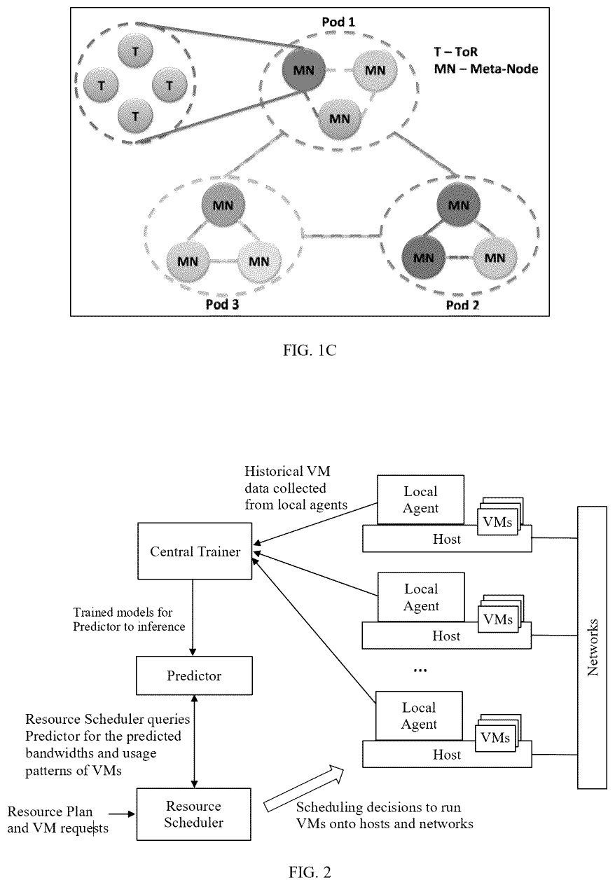

FIG. 2 illustrates an overall system architecture of resource scheduling. As shown in FIG. 2, the system may include a resource scheduler, a predictor, a central trainer and local agents, where the local agents may run based on hosts and networks included in the resource hierarchy as shown in FIG. 1A. The central trainer may collect historical data about VMs from the local agents, and train a model based on the historical data, where the trained model is used for the predictor's inference. When the resource scheduler receives a VM request, e.g., a request for scheduling a VM onto an endpoint and networks, the resource scheduler may query the predictor to obtain the predicted network bandwidth and the predicted network usage pattern for the VM. Then, the scheduler may schedule resources for the VM based on the queried result.

It should be noted that, the aforementioned VM request is illustrative but not restrictive, to be more general, the received request can be a request for scheduling a resource consumer onto an endpoint and networks. For simplicity, in the embodiments of the present disclosure, we may use VMs interchangeably as virtual endpoints including VMs, containers, computer applications and services; use hosts or (physical) servers interchangeably as physical endpoints; and use endpoints for virtual endpoints and/or physical endpoints. We also use resource consumers or simply consumers that have compute resources to run endpoints, and have network resources to exchange information among endpoints.

It should also be noted that, the resource scheduler, the predictor, the central trainer and the local agents may be implemented separately, may also be integrated, for example, the resource scheduler, the predictor and the central trainer may be integrated into a module. There may be other implementation manners, which is not limited in the embodiments of the present disclosure.

The above briefly describes technical concepts of the present disclosure with reference to the proposed system architecture or the exemplary scenario showing interaction among components of the system, and then specific embodiments of the present disclosure will be elaborated in the following description.

FIG. 3 shows a flowchart of a method for scheduling network resources according to one or more embodiments of the present disclosure. The method may include the following steps.

Step 302, a resource scheduler receives a resource request indicating at least one resource consumer from a client.

As mentioned before, the client may be a client from tenants, users, cloud services, workloads or application, etc. The resource scheduler is responsible for resource allocation. The client submits a resource request to the resource scheduler to get allocated resources to run applications or services, etc.

In a possible implementation, for each of the at least one resource consumer, the resource request may indicate resource requirement information for the resource consumer, identity information of at least one tenant associated with the resource consumer and at least one requested resource plan associated with the resource consumer, at least one of a requested network usage pattern or identity information of the resource consumer. The resource requirement information includes at least one of following items: an amount of CPU requested for the resource consumer, a size of a memory requested for the resource consumer, a network bandwidth requested for the resource consumer. The resource request may be initiated by the client, and the resource request may indicate input data for the pre-trained model to produce the prediction results of the requested resource consumer, with various possible information indicated by the resource request, the scheduling of the resource consumer would become more flexible, and user experience may be improved.

For example, the at least one tenant may be one or more users who get resources and services from the resource hierarchy in a cloud data center, and the identity information of each tenant would be ID of the tenant, if there are more than one tenant, each tenant may have its specific ID; the requested resource plan may be indicated by a resource plan ID (which may also be referred to as deployment ID), different applications (which may be from the same tenant or different tenants) may have different resource plans.

With respect to the resource requirement information, it may indicate the configuration of resources required by a resource consumer, which may also be referred to as VM flavor under some circumstances. In a possible implementation, the amount of CPU requested for the resource consumer would be the number of cores of the CPU, the network bandwidth would also be assured bandwidth required by the resource consumer (which would be described in detail with reference to FIG. 5).

In a possible implementation, the requested network usage pattern would reflect the pattern of the resource consumer, e.g., it may indicate the change of the bandwidth along with time, as one choice, the client would suggest an initial network usage pattern.

Besides, in a possible implementation, the identity information of the resource consumer would be an ID of the resource consumer. For example, in the case of releasing a resource consumer, the ID would be carried in the resource request from the client. In the case of asking for a new resource consumer into the resource hierarchy, it may be either carried in the resource request from the client, or assigned by the resource scheduler if the resource request does not provide an ID.

The above lists the indicated information about the resource consumer, it should be noted that, a part of or all of the listed information about the resource consumer may be indicated by the resource request, and the specific information about the resource consumer indicated by the resource request may be different according to actual implementations.

In an example, the resource requirement information for the resource consumer, the identity information of at least one tenant associated with the resource consumer, and the identity information of at least one requested resource plan associated with the resource consumer may be necessary in the case of creating a to-be-added resource consumer, while in the case of releasing an existing resource consumer, these may be omitted.

In another example, the resource request may indicate identity information of a to-be-released resource consumer, and in this case, the resource requirement information for the to-be-released resource consumer, the identity information of at least one tenant associated with the to-be-released resource consumer, and the identity information of at least one resource plan associated with the to-be-released resource consumer may be obtained based on the identity information of the to-be-released resource consumer.

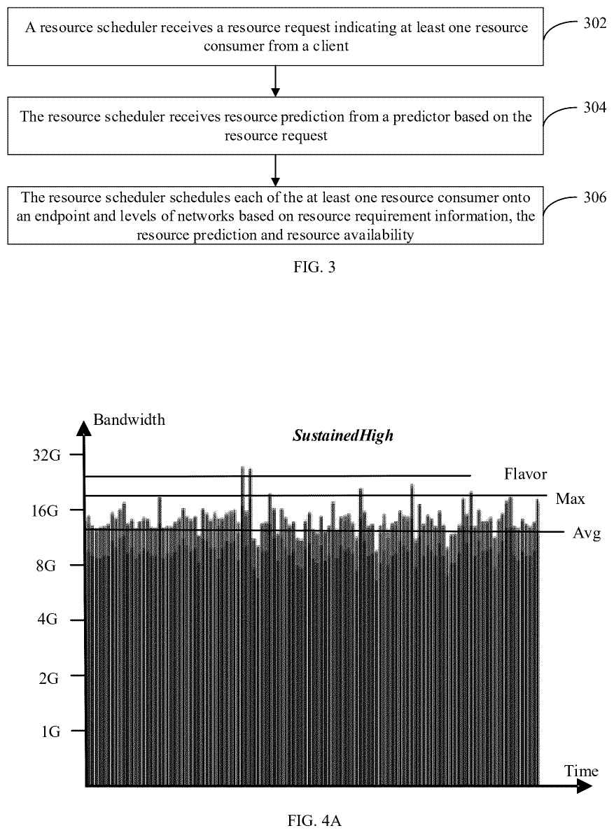

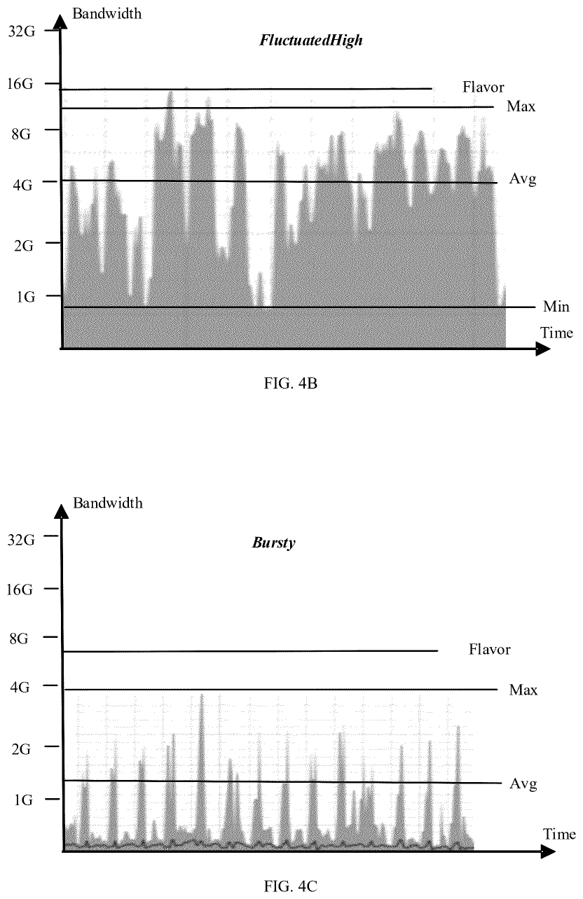

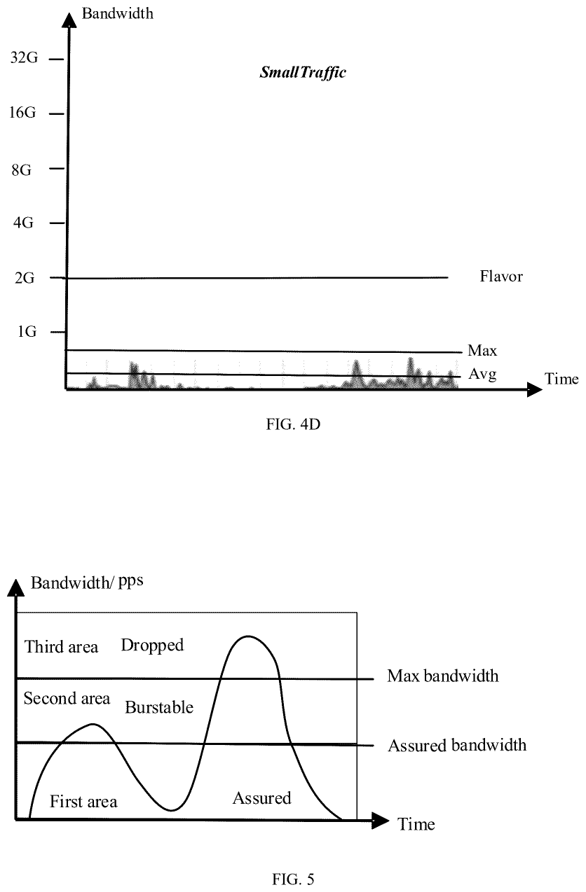

The network usage patterns may be classified according to actual needs, for example, there would be two patterns (small traffic and large traffic) or four patterns (SmallTraffic, SustainedHigh, FluctuatedHigh, Bursty). It should be noted that the definitions of network usage patterns are not restricted in the embodiments of the present disclosure. As described above, in an example, the requested network usage pattern of the to-be-added resource consumer may also be indicated by the resource request, where the network usage pattern may be one of a low bandwidth pattern (which may also be referred to as SmallTraffic, meaning low bandwidth without large changes, and may be a default pattern), a sustained high bandwidth pattern (which may also be referred to as SustainedHigh, meaning sustained high bandwidth with small changes), a fluctuated high bandwidth pattern (which may also be referred to as FluctuatedHigh, meaning high bandwidth with large fluctuation), or a bursty bandwidth pattern (which may also be referred to as Bursty, meaning low bandwidth with sudden bursts). FIGS. 4A-4D are schematic illustrations of SustainedHigh, FluctuatedHigh, Bursty, and SmallTraffic patterns, respectively. It should be noted that, in a cloud data center, usually, most of VMs may be in SmallTraffic pattern. A related research called these patterns “power law” or “80-20 rule”, which in this case means 98% of flows have peak throughput of less than 20 kbps or the top 1% of all services generate 64% of all the network traffic. It should be also noted that, there may be other implementation examples, which is not limited in the embodiments of the present disclosure.

Step 304, the resource scheduler receives resource prediction from a predictor based on the resource request.

The resource prediction includes a predicted network bandwidth and a predicted network usage pattern for each of the at least one resource consumer, where the resource prediction is obtained by the predictor through prediction inferring based on a pre-trained model, and the pre-trained model is obtained from local and central training. The predicted network bandwidth and the predicted network usage pattern can also be shown to users as a service functionality. The pre-trained model is a model trained for predicting a network bandwidth and a network usage pattern based on input data. Generally, this pre-trained model would be obtained based on two stages of local training and central training, the local training stage is more like a process of collecting statistic data locally, the collected data would then be gathered together and taken as input data for central training, this central training is a machine learning process during which the model could learn from the input data and output a result, and weights of the model may be adjusted based on certain loss functions, until a trained model is obtained. The specifics of the training process would be described later. It should be noted that the predictor may also be directly referred to as a pre-trained model, which is not limited in the embodiments of the present disclosure. Besides, the resource scheduler and the predictor may be separated or integrated as one device. In the separated case, the resource scheduler may send information about each of the at least one resource consumer to the predictor and receives the prediction result (the resource prediction) from the predictor. In the integrated case, the receiving of the resource prediction by the resource scheduler from the predictor would be internal information exchange of the integrated device, so the receiving of the resource prediction could be generally referred to as the obtaining of the resource prediction.

During the interference stage, the resource request may indicate information about each of the at least one resource consumer, the resource scheduler transmits the information about the resource consumer to the predictor after receiving the resource request. The predictor may invoke the pre-trained model from the central trainer, input the information about the resource consumer into the pre-trained model, and obtain outputs of the pre-trained model which can be referred to as the aforementioned resource prediction. Then, the predictor may transmit the resource prediction to the resource scheduler for further processing. In some cases, the resource scheduler may not pass all the information about each of the at least one resource consumer in the resource request to the predictor, but may analyze the resource request and pass necessary information to the predictor, which is not limited in the embodiments of the present disclosure.

With respect to the processing logic of the predictor, for each of the at least one resource consumer, the predictor would obtain the predicted network bandwidth and give the predicted network usage pattern based on the predicted network bandwidth, the predicted network bandwidth and the predicted network usage pattern would be together taken as the prediction result. In a possible implementation, the predicted network bandwidth may include a predicted maximum bandwidth, a predicted average bandwidth, a predicted minimum bandwidth or a predicted 95-percentile bandwidth. The predicted network usage pattern may be one of a low bandwidth pattern, a sustained high bandwidth pattern, a fluctuated high bandwidth pattern, or a bursty bandwidth pattern.

In a possible implementation, the predicted network usage pattern may be determined based on the predicted network bandwidth. As an example, rules can be set to identify which network usage pattern a coming new resource consumer belongs to, and the rules may be based on the predicted average bandwidth (which may be referred to as PredictedAvgBandwidth), the predicted maximum bandwidth (which may be referred to as PredictedMaxBandwidth) and a first threshold (which may also be referred to as a SmallTraffic_Threshold). In an example, the SmallTraffic_Threshold may be 1 Gbps.

Specifically, in a case that the predicted average bandwidth is greater than a first threshold (i.e., PredictedAvgBandwidth>SmallTraffic_Threshold), if a ratio of the predicted average bandwidth and the predicted maximum bandwidth (PredictedAvgBandwidth/PredictedMaxBandwidth) is greater than or equal to a second threshold (e.g., 0.9) and smaller than or equal to 1, the predicted network usage pattern of the resource consumer may be the sustained high bandwidth pattern; if the ratio of the predicted average bandwidth and the predicted maximum bandwidth is smaller than the second threshold and greater than or equal to a third threshold (e.g., 0.5), the predicted network usage pattern of the resource consumer may be the fluctuated high bandwidth pattern; if the ratio of the predicted average bandwidth and the predicted maximum bandwidth is smaller than the third threshold and greater than or equal to 0, the predicted network usage pattern of the resource consumer may be the bursty bandwidth pattern. In a case that the predicted average bandwidth is smaller than or equal to the first threshold (i.e., PredictedAvgBandwidth<=SmallTraffic_Threshold), the predicted network usage pattern of the resource consumer may be the low bandwidth pattern.

It should be noted that, the above example and specific values of the thresholds are only illustrative but not restrictive. Other examples may use more or less network usage patterns, or different predicted bandwidths (e.g., the predicted minimum bandwidth, the predicted 95-percentile bandwidth, etc.), which is not limited in the embodiments of the present disclosure. All parameters can be configurable. It should also be noted that, the prediction for bandwidth(s) and network usage pattern(s) may use timestamps or time-series data collected at local agents, which will be described later.

With respect to the training process of the pre-trained model, in a possible implementation, the pre-trained model is trained based on sampled network usage patterns of multiple groups of sampled resource consumers, bandwidth requirement information associated with sampled resource consumers in the multiple groups and sampled bandwidth utilization information of the sampled resource consumers in the multiple groups. Similarly, a sampled network usage pattern may be one of a low, a sustained high, a fluctuated high, or a bursty bandwidth patterns. A model based on machine learning (ML) may be trained on historical data of sampled resource consumers. Parameters about the ML-based on model can be adjusted based on the prediction results and the actual results, and the training of the ML-model may be completed if a difference between the prediction results and ground truth data is within a threshold. A common training method or process may be used, which is not limited in the embodiments of the present disclosure.

Regarding how to obtain the multiple groups of sampled resource consumers, in a possible implementation, the grouping of the sampled resource consumers is based on a type of an application running on each sampled resource consumer or a sampled network usage pattern of each sampled resource consumer. For example, resource consumers for the same/similar applications may be put into a group. For another example, resource consumers with the same usage pattern may be put into a group. Or some cluster analyses or clustering algorithms can be used, so that sampled resource consumers with similarities would be gathered together for training, so as to obtain relatively large training clusters or groups, thereby making the confidence of the trained model relatively high.

In a possible implementation, it is possible that based on some clustering or grouping principle, e.g., when grouping based on applications running on sampled resource consumers, some candidate groups may be obtained, in a case that one or more of the candidate groups have data sizes less than a preset data size, these sampled resource consumers can be put into a general group. Basically, relatively small-size candidate group may not have enough historical training data, and should be screened out and merged together into a general group. This processing of the input training data would be beneficial for improving the accuracies of the trained model with respective confidence levels. The larger and more specific group would have a higher confidence level on the training results. The smaller or more general group would have a lower confidence level on the training results.

In a possible implementation, for each sampled resource consumer in each of the multiple groups: the bandwidth requirement information of the sampled resource consumer includes at least one of: identity information of the sampled resource consumer (e.g., ID of VM, or VmId), identity information of at least one tenant associated with the sampled resource consumer and at least one resource plan associated with the sampled resource consumer (e.g., ID of a tenant and ID of a resource plan respectively, or referred to as TenantId and ResourcePlanId respectively), identity information of a type of an application associated with the sampled resource consumer, resource requirement information and resource utilization information of the sampled resource consumer, a network usage pattern of the sampled resource consumer (e.g., a network usage pattern of a VM, or referred to as NetworkUsagePatternPerVm), a creation time and a deletion time of the sampled resource consumer (e.g., created time and deleted time of a VM, or referred to as VmCreatedTime and VmDeletedTime respectively). The resource requirement information of the sampled resource consumer (e.g., VmFlavor) includes at least one of an amount of CPU requested for the sampled resource consumer (e.g., the number of CPU cores, or NumOfCpuCores), a size of a memory requested for the sampled resource consumer (e.g., parameter Memory), or an assured bandwidth requested for the sampled resource consumer (e.g., AssuredBandwidth). In a possible implementation, the assured bandwidth is the bandwidth requirement information. In a possible implementation, for each sampled resource consumer in each of the multiple groups, the sampled bandwidth utilization information of the sampled resource consumer indicates a historical bandwidth utilization during the sampled resource consumer lifetime and includes at least one of following items: a maximum utilized bandwidth, an average utilized bandwidth, a minimum utilized bandwidth or a 95-percentile utilized bandwidth (e.g., the maximum, the 95-percentile, the average, the minimum are referred to as UtilizedMaxBandwidthPerVm, UtilizedP95BandwidthPerVm, UtilizedAvgBandwidthPerVm, UtilizedMinBandwidthPerVm, respectively) during the sampled resource consumer lifetime.

The training of the ML-based model may be divided into two levels: statistics at the local agents and training at the central trainer for high efficiency. In a possible implementation, for each sampled resource consumer in each of the multiple groups, the bandwidth requirement information and the sampled bandwidth utilization information are collected at each local host, e.g., by the local agents. The sampled network usage pattern is determined at each local host based on the sampled bandwidth utilization information of the sampled resource consumer, e.g., the aforementioned determination manner may be used. The training of the pre-trained model is performed for each of the multiple groups at a central location based on the bandwidth requirement information, the sampled bandwidth utilization information and the sampled network usage pattern from local hosts.

In an example, the local training is performed locally with the help of the local agents, since there are a huge number of VMs in a large cloud data center, data volumes of frequent sampling may be impractical if the data processing is done only in a central place. Therefore, the bandwidth utilizations of VMs are sampled at a time interval (e.g., 5 minutes) on each host by a local agent to get statistics of maximum (max)/95-percentile (p95)/average/minimum (min) utilized bandwidths and a recognized network usage pattern per VM lifecycle. As shown in table 1, the input features may be used for sampling the bandwidth utilizations of VMs, and statistical features are obtained based on the sampled bandwidth utilizations. Then the per-VM historical data of the max/p95/average/min utilized bandwidths and the recognized network usage pattern are sent from the hosts to a central place (i.e., the aforementioned central location, or the central trainer) for central training. NetworkUsagePatternInitial (i.e., an initial network usage pattern) hinted initially by an expert user or cloud provider could help speed up training and increase accuracy. As described above, this initial network usage pattern would be carried in the resource request from the client to the resource scheduler.

TABLE 1

| | | Statistical features from local |
|---|---|---|
| | | hosts based on sampled |
| Input features for local agents | | historical data |
| VmId | [symbol] | UtilizedMaxBandwidthPerVm |
| TenantId | | UtilizedP95BandwidthPerVm |
| ResourcePlanId | | UtilizedAvgBandwidthPerVm |
| VmFlavor (including | | UtilizedMinBandwidthPerVm |
| NumOfCpuCores, Memory, | | NetworkUsagePatternPerVm |
| AssuredBandwidth) | | VmCreatedTime |
| NetworkUsagePatternInitial | | VmDeletedTime |

At the central trainer, the central training is done in 2 steps. Step 1 is to group or cluster VMs of the same/similar applications or usage patterns into a bucket, which can be done using a clustering tool like k-means or decision-tree, based on input features like TenantId, ResourcePlanId and VmFlavor. If the historical data size of a bucket is less than a threshold, the VMs in the bucket can be mixed into a single general bucket, meaning that these VMs are relatively new, or not enough historical data are observed to form a separate group or cluster. Step 2 is to use tools like decision-tree or multi-variable polynomial regression to train the model per bucket based on the selected input features and their corresponding UtilizedBandwidthPerVm and NetworkUsagePatternPerVm outputted from the local hosts.

TABLE 2

| Input and statistical features | | Output features from central |
|---|---|---|
| from local hosts | | training |
| VmId | [symbol] | PredictedMaxBandwidth |
| TenantId | | PredictedP95Bandwidth |
| ResourcePlanId | | PredictedAvgBandwidth |
| VmFlavor (including | | PredictedMinBandwidth |
| NumOfCpuCores, Memory, | | PredictedNetworkUsagePattern |
| AssuredBandwidth) | | |
| NetworkUsagePatternInitial | | |
| UtilizedMaxBandwidthPerVm | | |
| UtilizedP95BandwidthPerVm | | |
| UtilizedAvgBandwidthPerVm | | |
| UtilizedMinBandwidthPerVm | | |
| NetworkUsagePatternPerVm | | |
| VmCreatedTime | | |
| VmDeletedTime | | |

As described above, prediction is done by inference when a new VM request is received, the resource scheduler sends requested features of the new VM indicated by the new VM request to the predictor. The requested features may serve as inputs of the trained model for a predictor to obtain the predicted bandwidth (e.g., PredictedMaxBandwidth, PredictedP95Bandwidth, PredictedAvgBandwidth, PredictedMinBandwidth) and the predicted network usage pattern (i.e., PredictedNetworkUsagePattern) of the VM.

FIG. 5 is a schematic illustration of bandwidth level division. A VM flavor (or allocation spec, AllocationSpec) offered by a cloud provider to a tenant usually includes assured and maximal network bandwidths (or referred to as pps-packets per second). The assured bandwidth indicates the (soft) minimum bandwidth (the first area) that the system guarantees for a VM when there is bandwidth contention; and burstable to the second area. The maximal bandwidth indicates the maximum bandwidth that can be used by a VM when the system has sufficient bandwidth, but not guaranteed if there is contention, any traffic goes beyond the maximum bandwidth (the third area) may be blocked or dropped.

The utilized bandwidths of a VM may go higher than its AssuredBandwidth. However, when a new request VM comes, considering the predicted bandwidths are just statistics, the allocated bandwidths=<AssuredBandwidth. The resource scheduler allocates bandwidths=<AssuredBandwidth for the new VM based on the predicted bandwidths. It can be seen from the aforementioned two-level training, parameter of NetworkUsagePatternInitial may be hinted initially by a user or a cloud provider, may be refined to NetworkUsagePatternPerVm, and further refined to PredictedNetworkUsagePattern based on ML and pattern recognition.

Step 306, the resource scheduler schedules each of the at least one resource consumer onto an endpoint and levels of networks based on resource requirement information, the resource prediction and resource availability. The resource availability may include the total, used and/or available resources (e.g., CPUs, memory, and network bandwidths) at placement domains of the endpoints and levels of networks.

A data center network may include multiple endpoints and multiple levels of networks, as shown in FIGS. 1A-1C. The placement strategy of the resource consumer can be determined based on the resource requirement information, the resource prediction and the resource availability, where the placement strategy may define how to allocate bandwidths for the resource consumer onto the endpoint and the levels of networks.

In a possible implementation, step 306 of FIG. 3 may be implemented as follows: the resource scheduler schedules each of the at least one resource consumer with a first bandwidth onto the endpoint based on the predicted network bandwidth and the predicted network usage pattern; and schedules each of the at least one resource consumer with corresponding second bandwidths onto the levels of networks based on the first bandwidth. The determination for the first bandwidth is based on the prediction results output by the pre-trained model, and the determination for the second bandwidths may be based on the first bandwidth with a bottom-up percentage, which will be explained in the following. In this way, the scheduling of the resource consumer would be carried out in a bottom-up manner, the bandwidth for the endpoint is first determined as the first bandwidth, and then the levels of networks are determined, based on the first bandwidth, as the second bandwidths, and so on going up to the upper levels. In this way, the resource allocation and releasing of the resource consumer would be simpler than the existing arts.

In an example, the rules to allocate the network bandwidth of a VM at the host-level may be based on the prediction of bandwidths and recognition of network usage pattern. Specifically, the rules may be determined based on the predicted network usage pattern, the predicted average bandwidth, and the predicted maximum bandwidth. In a case that the predicted network usage pattern of the VM is the sustained high bandwidth pattern, the first bandwidth allocated to the VM at the host-level may be the predicted maximum bandwidth. In a case that the predicted network usage pattern of the VM is the fluctuated high bandwidth pattern, the first bandwidth may be obtained by adjusting the predicted maximum bandwidth with an adjustment factor, e.g., PredictedMaxBandwidth*F, where the adjustment factor F is greater than 0 and smaller than 1. F may be associated with the fluctuation degree, e.g., F=0.9. In a case that the predicted network usage pattern of the VM is the bursty bandwidth pattern, the first bandwidth may be a weighted sum of the predicted maximum bandwidth and the predicted average bandwidth, e.g., PredictedMaxBandwidth*(1.0−W)+PredictedAvgBandwidth*W, where W is a weighted value, 0.0<W<1.0. W may be associated with the burst degree, e.g., W=0.5. In a case that the predicted network usage pattern of the VM is the low bandwidth pattern, the first bandwidth may be the predicted average bandwidth.

It should be noted that, the above example, specific values of the adjustment factor and the weighted value are only illustrative but not restrictive. Other examples may use more or less network usage patterns, or different predicted bandwidths (e.g., the predicted minimum bandwidth, the predicted 95-percentile bandwidth, etc.) to form different rules, which is not limited in the embodiments of the present disclosure. All parameters are configurable. Allocated bandwidths and recognized network usage patterns can be shown to users as adjustments based on the assured bandwidth requirements and initial network usage patterns hinted by the users.

The above describes the determination for the first bandwidth, next the determination for the second bandwidths will be introduced.

In a possible implementation, the resource scheduler determines the corresponding second bandwidths onto the levels of networks based on the first bandwidth for each of the at least one resource consumer. For each of the levels of networks, the resource scheduler determines, based on the predicted network usage pattern for each of the at least one resource consumer, whether a second bandwidth at a network level meets a preset bandwidth requirement for the network level. Upon determining that the corresponding second bandwidths meet preset bandwidth requirements for the levels of networks, the resource scheduler schedules each of the at least one resource consumer with the corresponding second bandwidths onto the levels of networks. The to-be-allocated second bandwidths would be calculated first, and then verification for the calculated second bandwidths would be performed against the available bandwidths at the levels of networks, in this way, the allocated second bandwidths can be more reasonable, and network bandwidths can be better utilized than the existing arts.

In a possible implementation, the determination of the second bandwidths for each of the at least one resource consumer may be as follows. For a first network level among the levels of networks, a second bandwidth for the resource consumer at the first network level is obtained by multiplying the first bandwidth for the endpoint and a bandwidth percentage for the first network level. For network levels other than the first network level, a second bandwidth for the resource consumer at an (n+1)-th network level is obtained by multiplying a second bandwidth for the resource consumer at an n-th network level and a bandwidth percentage for the (n+1)-th network level, where n is an integer greater than or equal to 1. The bandwidth percentage is greater than or equal to 0.0 or 0%, and smaller than or equal to 1.0 or 100%. Such VM self-contained algorithm, e.g., bottom-up percentage algorithm may be used for determining the second bandwidths. The algorithm first decides the VM's bandwidth B(0) when it is placed at a physical host. Then, the algorithm goes up one level at a time to decide the bandwidth B(n) cross multiple levels of placement domains by multiplying P(i) (i.e., the aforementioned bandwidth percentage), so that

$$B ( n ) = B ( 0 ) * {\prod }_{i = 0}^{n} P ( i ) ,$$

where P(0)=1.0, for the placement domains at the n-th network level. Similarly, the bandwidths at all network levels are all freed up when the VM is released. Here, we can see that the endpoint or host level bandwidth B(0) could also be viewed as a special case of this formula when n=0, i.e.,

$$B ( 0 ) = B ( 0 ) * {\prod }_{i = 0}^{0} P ( 0 ) = B ( 0 ) * 1.0 .$$

In a possible implementation, a second bandwidth for the resource consumer at the n-th network level is obtained by further multiplying a promotion rate for the n-th network level, where the promotion rate is greater than 0.0, and smaller than or equal to 1.0. When allocating network resources for new resource consumers, e.g., allocating network resources for high-level placement domains, a promotion rate L(i) may be used at placement domain level i to promote more network resource sharing at level i, where 0.0<L(i)≤1.0. In this case,

$$B ( n ) = B ( 0 ) * {\prod }_{i = 0}^{n} P ( i ) * L ( i ) .$$

The higher a level of a placement domain, the smaller L(i) it may have, therefore more promotion can be achieved by a discounted price (because less B(n) would be deducted from the available bandwidth of the n-th level placement domain). Usually a high level placement domain has more aggregated total bandwidth, and most network communications of cloud applications or services could be done below a low-level of placement domains, leaving some bandwidth quotas designed for the high-level placement domains unused, thus the unused quotas could be further oversubscribed. The promotion rate L(i) may be initially determined as a default value 1.0, which means no promotion, and may also be dynamically changed according to the current network situations. The similar effect of L(i) may also be achieved by dynamic reconfiguration of the oversubscription rate or available bandwidth.

Regarding the specific value of the bandwidth percentage P(i), rules may be set to decide a P(i) each time when allocating a bandwidth for a VM on a placement domain/) at n-th level from bottom to up. In a possible implementation, for each of the at least one resource consumer, the resource request indicates whether communication partners of a resource consumer in a placement domain at the n-th network level are all inside the placement domain. In a case that the first bandwidth is smaller than or equal to a threshold (e.g., VM's B(0) is <=SmallTraffic_Threshold), or the communication partners of the resource consumer are all inside the placement domain, the bandwidth percentage P(n) for the n-th network level is set to 0.0. This means that a SmallTraffic VM will not have its own bandwidth allocated at n-th level placement domain; instead, it shares a reserved bandwidth of SmallTraffic_SharedBandwidth with other SmallTraffic VMs cross n-th level placement domains. And if any affinity or placement constraints require that the VM's communication partners are all inside/), then P(n)=0.0.

In a case that the communication partners of the resource consumer are all outside the placement domain, the bandwidth percentage P(n) for the n-th network level is equal to 1.0. If any anti-affinity/placement constraints require that the VM's communication partners are all outside D), then P(n)=1.0. In other cases, the bandwidth percentage for the placement domain at the n-th network level is set to an oversubscription rate between the n-th network level and an (n+1)-th network level. That is, P(n)=R, where R is the oversubscription rate.

A more accurate bandwidth percentage P(n) may be determined based on actual rules and situations.

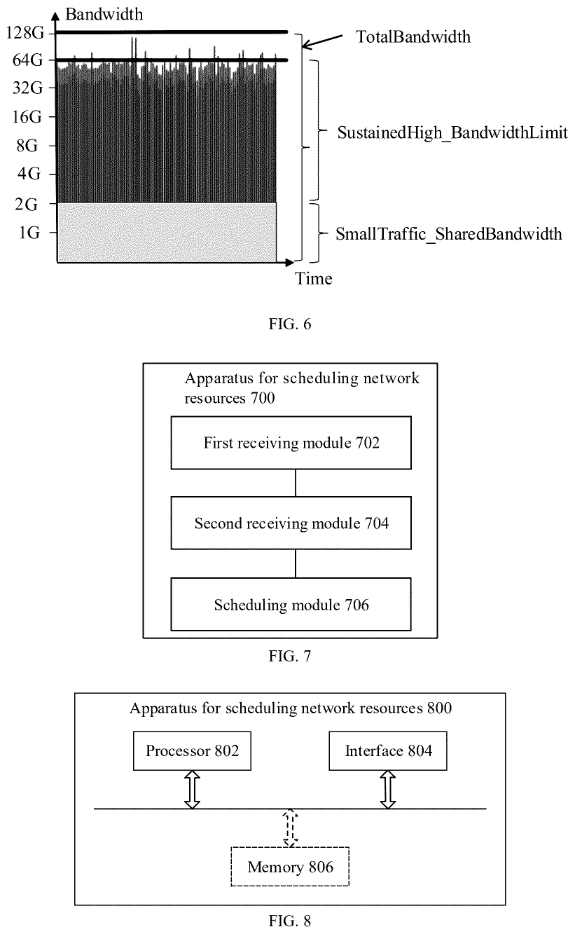

In some cases, before allocating bandwidths for VMs on a network layer, it may be determined whether the to-be-allocated bandwidths meet corresponding requirements. FIG. 6 is a schematic illustration of bandwidths associated with the network usage patterns, and the preset bandwidth requirement may be described with reference to FIG. 6. In a case that the predicted network usage pattern for a resource consumer is a low bandwidth pattern, the second bandwidth being allocated to the resource consumer at each of the levels of networks may be from a reserved bandwidth quota, where the reserved bandwidth quota is shared among resource consumers with the low bandwidth pattern. The reserved bandwidth quota may be referred to as SmallTrafficSharedBandwidth. That is, all SmallTraffic VMs share the reserved bandwidth quota of SmallTrafficSharedBandwidth cross n-th level placement domains. In other words, in this case, no second bandwidth would be allocated to the resource consumer, i.e., no bandwidth is deducted from SmallTrafficSharedBandwidth.

In a case that the predicted network usage pattern for the resource consumer is a sustained high bandwidth pattern, for each of the levels of networks, the second bandwidth being allocated to the resource consumer at the network level may be from an available bandwidth and a sustained high available bandwidth. The available bandwidth may be referred to as Available Bandwidth that initially equals to TotalBandwidth in FIG. 6, and the sustained high available bandwidth may be referred to as SustainedHighAvailableBandwidth that initially equals to SustainedHighBandwidthLimit in FIG. 6. It means that the to-be-allocated bandwidth is deducted from both AvailableBandwidth and SustainedHighAvailable Bandwidth. When a SustainedHigh VM at an n-th level placement domain D has its bottom-up percentage P(n)=1.0, it may generate bandwidth contention if the n-th level network has oversubscription, this means placement domain D's uplink aggregated bandwidth is smaller than the aggregated downlink bandwidth. If many such VMs are from placement domain D without control, they will generate a hotspot on D's uplink causing packet losses. To control this, for each n-th level placement domain D, in addition to the AvailableBandwidth capacity, a limitation may be introduced to limit bandwidth consumption of SustainedHigh VMs on D from VMs inside D: SustainedHighBandwidthLimit<TotalBandwidth, and AvailableBandwidth<SustainedHighAvailableBandwidth. If the current available bandwidth on D is Available Bandwidth≤TotalBandwidth, and a non-SmallTraffic new VM in D is allocated its B(n) on D cross n-th level placement domains, then the remaining AvailableBandwidth=Available Bandwidth−B(n). If the new VM is a SustainedHigh VM, assuming the current available bandwidth on D is SustainedHighAvailable Bandwidth≤SustainedHighBandwidthLimit, then the remaining SustainedHighAvailableBandwidth=SustainedHighAvailableBandwidth−B(n). If the remaining AvailableBandwidth <0 or remaining SustainedHighAvailableBandwidth is <0, the new VM cannot be placed in D.

In other cases, for each of the levels of networks, the second bandwidth being allocated to the resource consumer at the network level is only from the available bandwidth. It means that the to-be-allocated bandwidth is deducted only from AvailableBandwidth. For a non-SmallTraffic and non-SustainedHigh new VM, it only has one deduction. For a SustainedHigh new VM, it has both deductions, one on AvailableBandwidth, another on SustainedHighAvailableBandwidth. The above is to make sure that non-SmallTraffic and non-SustainedHigh VMs are only limited by TotalBandwidth. SustainedHigh VMs are limited by both TotalBandwidth and SustainedHighBandwidthLimit.

The bandwidth allocation for the requested resource consumer may be more accurate and more reasonable through the above described methods, bandwidth contention with other resource consumers may be avoided, and there would be less or no impact on the previously-allocated bandwidths.

In the case that the to-be-allocated second bandwidths do not meet the above rules, another endpoint may be selected, recalculation of corresponding second bandwidths on levels of network may be performed based on the first bandwidth of another endpoint, and then the above rules may be repeated. One or more rounds of selections may be performed until the resource requirements are met.

It should also be noted that, the case of allocating bandwidths for a single resource consumer is take as an example, and bandwidths can be allocated for two or more resource consumers in a similar way.

Based on the aforementioned solutions, in response to a resource request for a resource consumer, the resource scheduler obtains resource prediction including the predicted network bandwidth and the predicted network usage pattern, and schedules bandwidths for the resource consumer based on the resource requirement information, the resource prediction and the resource availability. The network bandwidths for the resource consumer are allocated based on the predicted network bandwidth and the predicted network usage pattern, and network bandwidth utilizations at the endpoint and the levels of networks can be improved.

In summary, the solution for scheduling network resources in the embodiments of the present disclosure is based on network bandwidth prediction and network usage pattern recognition which are based on machine learning from sampled historical data. When placing resource consumers at the physical endpoint level and oversubscribed network levels in cloud data centers, bandwidth allocations aim to save network costs, increase network utilization, and facilitate network resource fair sharing, load-balancing and non-exclusiveness.

Three rule-engine stages (i.e., ML-based training and prediction stage, endpoint-level allocation stage, and network-level allocation stage) are proposed for topology-aware, rule-based placement and multi-level network bandwidth allocation of resource consumers on endpoints and networks. Rules are applied in the order of these stages. At the ML-based training and prediction stage, network bandwidth training, network bandwidth prediction and network usage pattern recognition of VMs running on the allocated resource consumers' resources are completed based on the VMs' historical data sampled by the local agents on every host and the central trainer in a cloud data center. At the endpoint-level allocation stage, network bandwidths of endpoints for new resource consumers are allocated based on the predicted bandwidths and the recognized network usage patterns. At the network-level allocation stage, bottom-up percentage algorithm is used for network bandwidth allocation on multiple network levels (e.g., switches, routers, network function nodes other than the endpoints) for new resource consumers.

In a cloud data center, the topology-based network resources such as bandwidths or pps (packets per second) are more sharable, compressible and tolerable than the host-based resources such as CPU and memory, because of statistical nature of packet multiplexing of network workloads. Although there may be an oversubscription ratio between two levels, there are more aggregate bandwidths and more routing paths at a high-level placement domain than a low-level placement domain (VMs are placed). In addition, for new resource consumers that need large or small bandwidths on a network layer, some rules may be set to avoid bandwidth contention, i.e., the aforementioned methods for the calculated bandwidths, not repeated here.

Next, embodiments of products related to the method for scheduling network resources will be described.

FIG. 7 shows a block diagram of an apparatus for scheduling network resources according to one or more embodiments of the present disclosure. As shown in FIG. 7, the apparatus for scheduling network resources 700 may include a first receiving module 702, a second receiving module 704, and a scheduling module 706. The first receiving module 702 is configured to receive a resource request indicating at least one resource consumer. The second receiving module 704 is configured to receive resource prediction based on the resource request, where the resource prediction includes a predicted network bandwidth and a predicted network usage pattern for each of the at least one resource consumer, where the resource prediction is obtained through prediction inferring based on a pre-trained model, and the pre-trained model is obtained from local and central training. The scheduling module 706 is configured to schedule, based on resource requirement information, the resource prediction and resource availability, each of the at least one resource consumer onto an endpoint and levels of networks.

It should be noted that, the first receiving module and the second receiving module are only illustrative for their functions, in practice, the functions of the first receiving module and the second receiving module may be implemented by one receiving module, which is not limited here. It should also be noted that, the functions of the receiving modules and the scheduling module may also be implemented by a module.

In a possible implementation, for each of the at least one resource consumer, the resource request indicates the resource requirement information for the resource consumer, identity information of at least one tenant associated with the resource consumer and at least one requested resource plan associated with the resource consumer, at least one of a requested network usage pattern or identity information of the resource consumer. The resource requirement information includes at least one of following items: an amount of CPU requested for the resource consumer, a size of a memory requested for the resource consumer, a network bandwidth requested for the resource consumer.

In a possible implementation, the scheduling module is specifically configured to: schedule each of the at least one resource consumer with a first bandwidth onto the endpoint based on the predicted network bandwidth and the predicted network usage pattern; and schedule each of the at least one resource consumer with corresponding second bandwidths onto the levels of networks based on the first bandwidth.

In a possible implementation, the scheduling module is specifically configured to: determine, for each of the at least one resource consumer, the corresponding second bandwidths onto the levels of networks based on the first bandwidth; for each of the levels of networks, determine, based on the predicted network usage pattern for each of the at least one resource consumer, whether a second bandwidth at a network level meets a preset bandwidth requirement for the network level; and upon determining that the corresponding second bandwidths meet preset bandwidth requirements for the levels of networks, schedule each of the at least one resource consumer with the corresponding second bandwidths onto the levels of networks.

In a possible implementation, the preset bandwidth requirement may be as follows. In a case that the predicted network usage pattern for a resource consumer is a low bandwidth pattern, the second bandwidth being allocated to the resource consumer at each of the levels of networks is from a reserved bandwidth quota, where the reserved bandwidth quota is shared among resource consumers with the low bandwidth pattern. In a case that the predicted network usage pattern for the resource consumer is a sustained high bandwidth pattern, for each of the levels of networks, the second bandwidth being allocated to the resource consumer at the network level is from an available bandwidth and a sustained high available bandwidth. In other cases, for each of the levels of networks, the second bandwidth being allocated to the resource consumer at the network level is from the available bandwidth.

In a possible implementation, the determination of the second bandwidths for each of the at least one resource consumer may include the following. For a first network level among the levels of networks, a second bandwidth for the resource consumer at the first network level is obtained by multiplying the first bandwidth for the endpoint and a bandwidth percentage for the first network level. For network levels other than the first network level, a second bandwidth for the resource consumer at an (n+1)-th network level is obtained by multiplying a second bandwidth for the resource consumer at an n-th network level and a bandwidth percentage for the (n+1)-th network level, where n is an integer greater than or equal to 1. The bandwidth percentage is greater than or equal to 0.0 or 0%, and smaller than or equal to 1.0 or 100%.

In a possible implementation, a second bandwidth for the resource consumer at the n-th network level is obtained by further multiplying a promotion rate for the n-th network level, where the promotion rate is greater than 0.0, and smaller than or equal to 1.0.

In a possible implementation, for each of the at least one resource consumer, the resource request indicates whether communication partners of a resource consumer in a placement domain at the n-th network level are all inside the placement domain. In a case that the first bandwidth is smaller than or equal to a threshold, or the communication partners of the resource consumer are all inside the placement domain, the bandwidth percentage for the n-th network level is set to 0.0. In a case that the communication partners of the resource consumer are all outside the placement domain, the bandwidth percentage for the n-th network level is set to 1.0. In other cases, the bandwidth percentage for the placement domain at the n-th network level is set to an oversubscription rate between the n-th network level and an (n+1)-th network level.

In a possible implementation, the predicted network usage pattern is one of a low bandwidth pattern, a sustained high bandwidth pattern, a fluctuated high bandwidth pattern, or a bursty bandwidth pattern.

In a possible implementation, the pre-trained model is trained based on sampled network usage patterns of multiple groups of sampled resource consumers, bandwidth requirement information of sampled resource consumers in the multiple groups and sampled bandwidth utilization information of the sampled resource consumers in the multiple groups.

In a possible implementation, for each sampled resource consumer in each of the multiple groups, the bandwidth requirement information and the sampled bandwidth utilization information are collected at each local host, and the sampled network usage pattern is determined at each local host based on the sampled bandwidth utilization information of the sampled resource consumer. The training of the pre-trained model is performed for each of the multiple groups at a central location based on the bandwidth requirement information, the sampled bandwidth utilization information and the sampled network usage pattern from local hosts.

In a possible implementation, the grouping of the sampled resource consumers is based on a type of an application running on each sampled resource consumer or a sampled network usage pattern of each sampled resource consumer.

In a possible implementation, in a case that a candidate group has a data size less than a preset data size, one or more sampled resource consumers in the candidate group are mixed into a general group.

In a possible implementation, for each sampled resource consumer in each of the multiple groups: the bandwidth requirement information of the sampled resource consumer includes at least one of: identity information of the sampled resource consumer, identity information of at least one tenant associated with the sampled resource consumer and at least one resource plan associated with the sampled resource consumer, identity information of a type of an application associated with the sampled resource consumer, resource requirement information and resource utilization information of the sampled resource consumer, a network usage pattern of the sampled resource consumer, a creation time and a deletion time of the sampled resource consumer. The resource requirement information of the sampled resource consumer includes at least one of an amount of CPU requested for the sampled resource consumer, a size of a memory requested for the sampled resource consumer, or an assured bandwidth requested for the sampled resource consumer.

In a possible implementation, for each sampled resource consumer in each of the multiple groups, the sampled bandwidth utilization information of the sampled resource consumer indicates a historical bandwidth utilization during sampled resource consumer time and includes at least one of following items: a maximum utilized bandwidth, an average utilized bandwidth, a minimum utilized bandwidth or a 95-percentile utilized bandwidth during the sampled resource consumer lifetime.

The apparatus for scheduling network resources may be the implemented as described in the above method embodiments. It should be understood by a person skilled in the art that, the relevant description of the above modules in the embodiments of the present disclosure may be understood with reference to the relevant description of the method for scheduling network resources in the embodiments of the present disclosure.

FIG. 8 is a schematic structural diagram of an apparatus for scheduling network resources according to one or more embodiments of the present disclosure. As shown in FIG. 8, the apparatus for scheduling network resources 800 includes a processor 802, an interface 804 for communicating with other devices, and a memory 806. The memory 806 may be stored with computer execution instructions, and the processor 802 executes computer execution instructions stored in the memory 806 to enable the apparatus to execute any of the above methods.

In some aspects of the present disclosure, there is provided an apparatus for scheduling network resources including processing circuitry for executing any of the above methods. It should be understood that the apparatus can execute the steps in the above method embodiments, which will not be repeated here.

In some aspects of the present disclosure, there is provided an apparatus for scheduling network resources which includes a processor and a memory. The memory is storing instructions that cause the processor to perform any of the above methods.

In some aspects of the present disclosure, there is provided an apparatus for scheduling network resources which includes a processing circuitry for performing any of the above methods.

In some aspects of the present disclosure, there is provided a chip, including an input/output (I/O) interface and a processor, where the processor is configured to call and run computer execution instructions stored in a memory, to enable a device installing with the chip to execute any of the above methods.

In some aspects of the present disclosure, there is provided a computer-readable medium storing computer execution instructions which, when executed by a processor, cause the processor to execute any of the above methods.

In some aspects of the present disclosure, there is provided a computer program product including computer execution instructions which, when executed by a processor, cause the processor to execute any of the above methods.

In some aspects of the present disclosure, there is provided a computer program including computer execution instructions which, when executed by a processor, cause the processor to execute any of the above methods.

The embodiments may further be described using the following clauses.

Clause 1. A method for scheduling network resources, including:
receiving, by a resource scheduler from a client, a resource request indicating at least one resource consumer;
receiving, by the resource scheduler from a predictor, resource prediction based on the resource request, where the resource prediction includes a predicted network bandwidth and a predicted network usage pattern for each of the at least one resource consumer, where the resource prediction is obtained by the predictor through prediction inferring based on a pre-trained model, and the pre-trained model is obtained from local and central training; and
scheduling, by the resource scheduler based on resource requirement information, the resource prediction and resource availability, each of the at least one resource consumer onto an endpoint and levels of networks.

Clause 2. The method according to clause 1, where for each of the at least one resource consumer, the resource request indicates the resource requirement information for the resource consumer, identity information of at least one tenant associated with the resource consumer and at least one requested resource plan associated with the resource consumer, at least one of a requested network usage pattern or identity information of the resource consumer;
where the resource requirement information includes at least one of following items: an amount of CPU requested for the resource consumer, a size of a memory requested for the resource consumer, a network bandwidth requested for the resource consumer.

Clause 3. The method according to clause 1 or 2, where the scheduling, by the resource scheduler based on the resource requirement information, the resource prediction and the resource availability, each of the at least one resource consumer onto an endpoint and levels of networks includes:
scheduling, by the resource scheduler, each of the at least one resource consumer with a first bandwidth onto the endpoint based on the predicted network bandwidth and the predicted network usage pattern; and
scheduling, by the resource scheduler, each of the at least one resource consumer with corresponding second bandwidths onto the levels of networks based on the first bandwidth.

Clause 4. The method according to clause 3, where the scheduling, by the resource scheduler, each of the at least one resource consumer with the corresponding second bandwidths onto the levels of networks based on the first bandwidth includes:
determining, by the resource scheduler for each of the at least one resource consumer, the corresponding second bandwidths onto the levels of networks based on the first bandwidth;
for each of the levels of networks, determining, by the resource scheduler based on the predicted network usage pattern for each of the at least one resource consumer, whether a second bandwidth at a network level meets a preset bandwidth requirement for the network level; and
upon determining that the corresponding second bandwidths meet preset bandwidth requirements for the levels of networks, scheduling, by the resource scheduler, each of the at least one resource consumer with the corresponding second bandwidths onto the levels of networks.

Clause 5. The method according to clause 4, where the preset bandwidth requirement includes:
in a case that the predicted network usage pattern for a resource consumer is a low bandwidth pattern, the second bandwidth being allocated to the resource consumer at each of the levels of networks is from a reserved bandwidth quota, where the reserved bandwidth quota is shared among resource consumers with the low bandwidth pattern;
in a case that the predicted network usage pattern for the resource consumer is a sustained high bandwidth pattern, for each of the levels of networks, the second bandwidth being allocated to the resource consumer at the network level is from an available bandwidth and a sustained high available bandwidth;
in other cases, for each of the levels of networks, the second bandwidth being allocated to the resource consumer at the network level is from the available bandwidth.

Clause 6. The method according to clause 4, where the determination of the second bandwidths for each of the at least one resource consumer includes:
for a first network level among the levels of networks, a second bandwidth for the resource consumer at the first network level is obtained by multiplying the first bandwidth for the endpoint and a bandwidth percentage for the first network level;
for network levels other than the first network level, a second bandwidth for the resource consumer at an (n+1)-th network level is obtained by multiplying a second bandwidth for the resource consumer at an n-th network level and a bandwidth percentage for the (n+1)-th network level, where n is an integer greater than or equal to 1;
where the bandwidth percentage is greater than or equal to 0.0 or 0%, and smaller than or equal to 1.0 or 100%.

Clause 7. The method according to clause 6, where a second bandwidth for the resource consumer at the n-th network level is obtained by further multiplying a promotion rate for the n-th network level, where the promotion rate is greater than 0.0, and smaller than or equal to 1.0.

Clause 8. The method according to clause 6, where for each of the at least one resource consumer, the resource request indicates whether communication partners of a resource consumer in a placement domain at the n-th network level are all inside the placement domain;
in a case that the first bandwidth is smaller than or equal to a threshold, or the communication partners of the resource consumer are all inside the placement domain, the bandwidth percentage for the n-th network level is set to 0.0;
in a case that the communication partners of the resource consumer are all outside the placement domain, the bandwidth percentage for the n-th network level is set to 1.0;
in other cases, the bandwidth percentage for the placement domain at the n-th network level is set to an oversubscription rate between the n-th network level and an (n+1)-th network level.

Clause 9. The method according to any one of clauses 1 to 8, where the predicted network usage pattern is one of a low bandwidth pattern, a sustained high bandwidth pattern, a fluctuated high bandwidth pattern, or a bursty bandwidth pattern.

Clause 10. The method according to any one of clauses 1 to 9, where
the pre-trained model is trained based on sampled network usage patterns of multiple groups of sampled resource consumers, bandwidth requirement information of sampled resource consumers in the multiple groups and sampled bandwidth utilization information of the sampled resource consumers in the multiple groups.

Clause 11. The method according to clause 10, where
for each sampled resource consumer in each of the multiple groups, the bandwidth requirement information and the sampled bandwidth utilization information are collected at each local host, and the sampled network usage pattern is determined at each local host based on the sampled bandwidth utilization information of the sampled resource consumer;
the training of the pre-trained model is performed for each of the multiple groups at a central location based on the bandwidth requirement information, the sampled bandwidth utilization information and the sampled network usage pattern from local hosts.

Clause 12. The method according to clause 10 or 11, where the grouping of the sampled resource consumers is based on a type of an application running on each sampled resource consumer or a sampled network usage pattern of each sampled resource consumer.

Clause 13. The method according to clause 12, where in a case that a candidate group has a data size less than a preset data size, one or more sampled resource consumers in the candidate group are mixed into a general group.

Clause 14. The method according to any one of clauses 10 to 13, where for each sampled resource consumer in each of the multiple groups:
the bandwidth requirement information of the sampled resource consumer includes at least one of: identity information of the sampled resource consumer, identity information of at least one tenant associated with the sampled resource consumer and at least one resource plan associated with the sampled resource consumer, identity information of a type of an application associated with the sampled resource consumer, resource requirement information and resource utilization information of the sampled resource consumer, a network usage pattern of the sampled resource consumer, a creation time and a deletion time of the sampled resource consumer;
the resource requirement information of the sampled resource consumer includes at least one of an amount of CPU requested for the sampled resource consumer, a size of a memory requested for the sampled resource consumer, or an assured bandwidth requested for the sampled resource consumer.

Clause 15. The method according to any one of clauses 10 to 14, where for each sampled resource consumer in each of the multiple groups, the sampled bandwidth utilization information of the sampled resource consumer indicates a historical bandwidth utilization during sampled resource consumer lifetime and includes at least one of following items:
a maximum utilized bandwidth, an average utilized bandwidth, a minimum utilized bandwidth or a 95-percentile utilized bandwidth during the sampled resource consumer lifetime.

Although the present disclosure describes methods and processes with steps in a certain order, one or more steps of the methods and processes may be omitted or altered as appropriate. One or more steps may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may include a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

Although embodiments have been described above with reference to the accompanying drawings, those of skill in the art will appreciate that variations and modifications may be made without departing from the scope thereof as defined by the appended claims.

1. A method for scheduling network resources, comprising:
receiving, by a resource scheduler from a client, a resource request indicating at least one resource consumer;
receiving, by the resource scheduler from a predictor, resource prediction based on the resource request, wherein the resource prediction comprises a predicted network bandwidth and a predicted network usage pattern for each of the at least one resource consumer, wherein the resource prediction is obtained by the predictor through prediction inferring based on a pre-trained model, and the pre-trained model is obtained from local and central training; and
scheduling, by the resource scheduler based on resource requirement information, the resource prediction and resource availability, each of the at least one resource consumer onto an endpoint and levels of networks.

2. The method according to claim 1, wherein for each of the at least one resource consumer, the resource request indicates the resource requirement information for the resource consumer, identity information of at least one tenant associated with the resource consumer and at least one requested resource plan associated with the resource consumer, at least one of a requested network usage pattern or identity information of the resource consumer;
wherein the resource requirement information comprises at least one of following items: an amount of CPU requested for the resource consumer, a size of a memory requested for the resource consumer, a network bandwidth requested for the resource consumer.

3. The method according to claim 1, wherein the scheduling, by the resource scheduler based on the resource requirement information, the resource prediction and the resource availability, each of the at least one resource consumer onto an endpoint and levels of networks comprises:
scheduling, by the resource scheduler, each of the at least one resource consumer with a first bandwidth onto the endpoint based on the predicted network bandwidth and the predicted network usage pattern; and
scheduling, by the resource scheduler, each of the at least one resource consumer with corresponding second bandwidths onto the levels of networks based on the first bandwidth.

4. The method according to claim 3, wherein the scheduling, by the resource scheduler, each of the at least one resource consumer with the corresponding second bandwidths onto the levels of networks based on the first bandwidth comprises:
determining, by the resource scheduler for each of the at least one resource consumer, the corresponding second bandwidths onto the levels of networks based on the first bandwidth;
for each of the levels of networks, determining, by the resource scheduler based on the predicted network usage pattern for each of the at least one resource consumer, whether a second bandwidth at a network level meets a preset bandwidth requirement for the network level; and
upon determining that the corresponding second bandwidths meet preset bandwidth requirements for the levels of networks, scheduling, by the resource scheduler, each of the at least one resource consumer with the corresponding second bandwidths onto the levels of networks.

5. The method according to claim 4, wherein the preset bandwidth requirement comprises:
in a case that the predicted network usage pattern for a resource consumer is a low bandwidth pattern, the second bandwidth being allocated to the resource consumer at each of the levels of networks is from a reserved bandwidth quota, wherein the reserved bandwidth quota is shared among resource consumers with the low bandwidth pattern;
in a case that the predicted network usage pattern for the resource consumer is a sustained high bandwidth pattern, for each of the levels of networks, the second bandwidth being allocated to the resource consumer at the network level is from an available bandwidth and a sustained high available bandwidth;
in other cases, for each of the levels of networks, the second bandwidth being allocated to the resource consumer at the network level is from the available bandwidth.

6. The method according to claim 4, wherein the determination of the second bandwidths for each of the at least one resource consumer comprises:
for a first network level among the levels of networks, a second bandwidth for the resource consumer at the first network level is obtained by multiplying the first bandwidth for the endpoint and a bandwidth percentage for the first network level;
for network levels other than the first network level, a second bandwidth for the resource consumer at an (n+1)-th network level is obtained by multiplying a second bandwidth for the resource consumer at an n-th network level and a bandwidth percentage for the (n+1)-th network level, wherein n is an integer greater than or equal to 1;
wherein the bandwidth percentage is greater than or equal to 0.0 or 0%, and smaller than or equal to 1.0 or 100%.

7. The method according to claim 6, wherein a second bandwidth for the resource consumer at the n-th network level is obtained by further multiplying a promotion rate for the n-th network level, wherein the promotion rate is greater than 0.0, and smaller than or equal to 1.0.

8. The method according to claim 6, wherein for each of the at least one resource consumer, the resource request indicates whether communication partners of a resource consumer in a placement domain at the n-th network level are all inside the placement domain;
in a case that the first bandwidth is smaller than or equal to a threshold, or the communication partners of the resource consumer are all inside the placement domain, the bandwidth percentage for the n-th network level is set to 0.0;
in a case that the communication partners of the resource consumer are all outside the placement domain, the bandwidth percentage for the n-th network level is set to 1.0;
in other cases, the bandwidth percentage for the placement domain at the n-th network level is set to an oversubscription rate between the n-th network level and an (n+1)-th network level.

9. The method according to claim 1, wherein the predicted network usage pattern is one of a low bandwidth pattern, a sustained high bandwidth pattern, a fluctuated high bandwidth pattern, or a bursty bandwidth pattern.

10. The method according to claim 1, wherein
the pre-trained model is trained based on sampled network usage patterns of multiple groups of sampled resource consumers, bandwidth requirement information of sampled resource consumers in the multiple groups and sampled bandwidth utilization information of the sampled resource consumers in the multiple groups.

11. The method according to claim 10, wherein the grouping of the sampled resource consumers is based on a type of an application running on each sampled resource consumer or a sampled network usage pattern of each sampled resource consumer.

12. The method according to claim 11, wherein in a case that a candidate group has a data size less than a preset data size, one or more sampled resource consumers in the candidate group are mixed into a general group.

13. The method according to claim 10, wherein
for each sampled resource consumer in each of the multiple groups, the bandwidth requirement information and the sampled bandwidth utilization information are collected at each local host, and the sampled network usage pattern is determined at each local host based on the sampled bandwidth utilization information of the sampled resource consumer;
the training of the pre-trained model is performed for each of the multiple groups at a central location based on the bandwidth requirement information, the sampled bandwidth utilization information and the sampled network usage pattern from local hosts.

14. The method according to claim 10, wherein for each sampled resource consumer in each of the multiple groups:
the bandwidth requirement information of the sampled resource consumer comprises at least one of: identity information of the sampled resource consumer, identity information of at least one tenant associated with the sampled resource consumer and at least one resource plan associated with the sampled resource consumer, identity information of a type of an application associated with the sampled resource consumer, resource requirement information and resource utilization information of the sampled resource consumer, a network usage pattern of the sampled resource consumer, a creation time and a deletion time of the sampled resource consumer;
the resource requirement information of the sampled resource consumer comprises at least one of an amount of CPU requested for the sampled resource consumer, a size of a memory requested for the sampled resource consumer, or an assured bandwidth requested for the sampled resource consumer.

15. The method according to claim 10, wherein for each sampled resource consumer in each of the multiple groups, the sampled bandwidth utilization information of the sampled resource consumer indicates a historical bandwidth utilization during sampled resource consumer lifetime and comprises at least one of following items:
a maximum utilized bandwidth, an average utilized bandwidth, a minimum utilized bandwidth or a 95-percentile utilized bandwidth during the sampled resource consumer lifetime.

16. An apparatus for scheduling network resources, comprising at least one processor coupled with a memory, wherein the memory stores instructions that cause the at least one processor to execute the following steps:
receiving a resource request indicating at least one resource consumer;
receiving resource prediction based on the resource request, wherein the resource prediction comprises a predicted network bandwidth and a predicted network usage pattern for each of the at least one resource consumer, wherein the resource prediction is obtained through prediction inferring based on a pre-trained model, and the pre-trained model is obtained from local and central training; and
scheduling, based on resource requirement information, the resource prediction and resource availability, each of the at least one resource consumer onto an endpoint and levels of networks.

17. A non-transitory computer-readable medium storing computer execution instructions which, when executed by a processor, cause the processor to execute the following steps:
receiving a resource request indicating at least one resource consumer,
receiving resource prediction based on the resource request, wherein the resource prediction comprises a predicted network bandwidth and a predicted network usage pattern for each of the at least one resource consumer, wherein the resource prediction is obtained through prediction inferring based on a pre-trained model, and the pre-trained model is obtained from local and central training; and
scheduling, based on resource requirement information, the resource prediction and resource availability, each of the at least one resource consumer onto an endpoint and levels of networks.
